(19) United States
(12) Patent Application Publication
(10) Pub. No.: US 2007/0074269 A1
(43) Pub. Date: Mar. 29, 2007

(54) Video processing device, video recorder/playback module, and methods for use therewith

(76) Inventor: Hai Hua, Markham (CA)

Correspondence Address: GARLICK HARRISON & MARKISON, P.O. BOX 160727, AUSTIN, TX, 78716-0727, US

(21) Appl. No.: 11/504,320

(22) Filed: Aug. 15, 2006

Related U.S. Application Data
(63) Continuation-in-part of application No. 10/081,084, filed on Feb. 22, 2002.

(51) Int. Cl. H04N 7/16; H04N 7/173

(52) U.S. Cl. 725/151; 725/100; 725/131; 725/139

(57) ABSTRACT

A video record/playback module receives a video signal from a receiving module and produces a processed video signal for display on a first video display device. The video record/includes a driver interface module that stores a plurality of record settings, the plurality of record settings including first settings corresponding to the first video display device, and second settings corresponding to a second video display device. A driver module encodes the video signal based on the first settings to produce a first processed video signal in a first format, and contemporaneously encodes the video signal based on the second settings to produce a second processed video signal in a second format, wherein the first format is different from the second format. A memory module stores a plurality of compressed video files including a first compressed video file that is based on the first processed video signal.

### CROSS REFERENCE TO RELATED PATENTS

This patent is a continuation-in-part of copending U.S. patent application Ser. No. 10/081,084, entitled SYSTEM AND METHOD TO PROVIDE VIDEO TO A PLURALITY OF WIRELESS DISPLAY DEVICES, filed on Feb. 22, 2002, which is incorporated by reference herein in its entirety for all purposes.

### TECHNICAL FIELD OF THE INVENTION

The present invention relates to video recording and related methods used in devices such as digital video recorders and players.

### DESCRIPTION OF RELATED ART

Digital video recorders, that digitize and store a broadcast video signals, have gained popularity over the last several years. Users can select programs of interest and have easy access to the programs that they have recorded for playback at any time. The buffering that is used also allows live television broadcasts to be paused, rewound and played in slow motion, etc. Originally manufactured as stand alone devices, software applications, such as Microsoft Media Center Edition 2005 allow users to operate their computer as a digital video recorder.

In addition, handheld multifunction devices are being manufactured with video display functionality. Examples include the Apple iPod, Palm Treo, etc. While these devices are capable of playing digital video files, they cannot receive broadcast video signals and do not contain the functions and features of a digital video recorder. Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIGS. 1-3 present pictorial diagram representations of a various video processing devices in accordance with embodiments of the present invention.

FIG. 4 presents a block diagram representation of a video processing device 125 in accordance with an embodiment of the present invention.

FIG. 5 presents a block diagram representation of a video record/playback module 102 in accordance with an embodiment of the present invention.

FIG. 6 presents a pictorial representation of a video device setup menu 230 in accordance with an embodiment of the present invention.

FIG. 7 presents a pictorial representation of a recording defaults menu 240 in accordance with an embodiment of the present invention.

FIG. 8 presents a pictorial representation of a recording options menu 250 in accordance with an embodiment of the present invention.

FIG. 9 presents a flowchart representation of a method in accordance with an embodiment of the present invention.

FIG. 10 presents a flowchart representation of a method in accordance with an embodiment of the present invention.

FIG. 11 presents a flowchart representation of a method in accordance with an embodiment of the present invention.

FIG. 12 presents a flowchart representation of a method in accordance with an embodiment of the present invention.

### DETAILED DESCRIPTION OF THE INVENTION INCLUDING THE PRESENTLY PREFERRED EMBODIMENTS

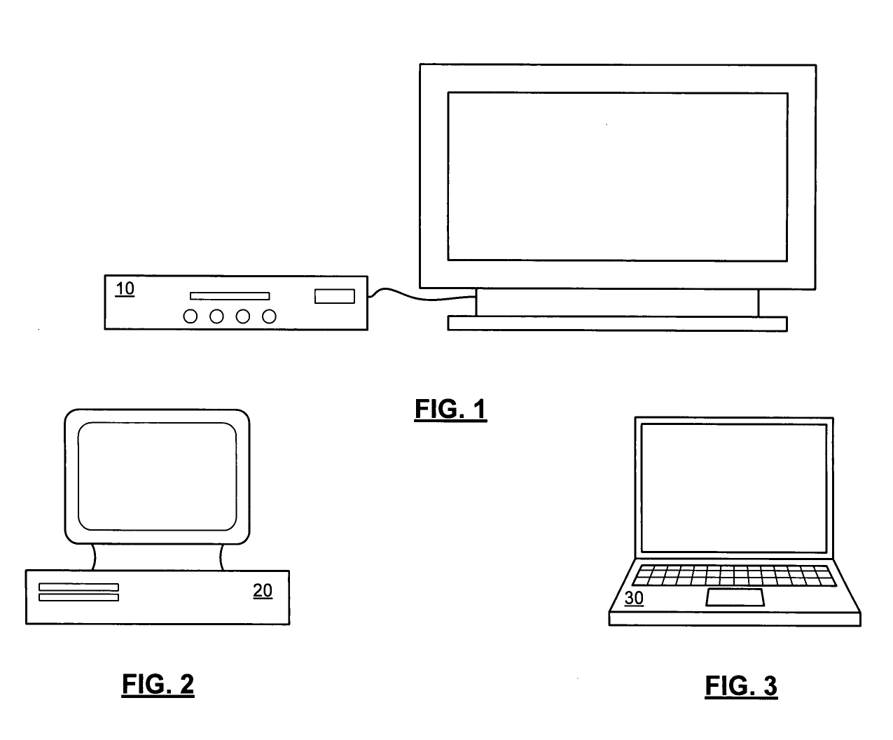

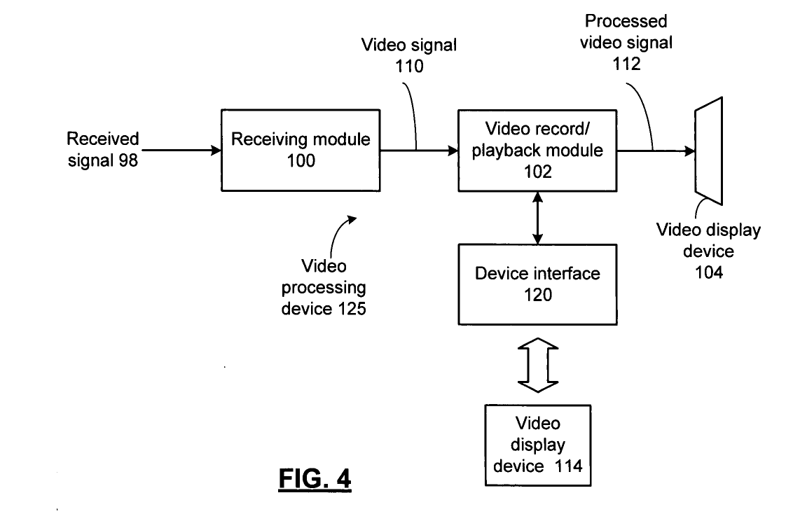

FIGS. 1-3 present pictorial diagram representations of a various video processing devices in accordance with embodiments of the present invention. In particular, set top box 10 with built-in digital video recorder functionality or a stand alone digital video recorder, computer 20 and portable computer 30 illustrate electronic devices that incorporate a video processing device 125 that includes one or more features or functions of the present invention. While these particular devices are illustrated, video processing device 125 includes any device that is capable of recording and storing video content in accordance with the methods and systems described in conjunction with FIGS. 4-12 and the appended claims.

FIG. 4 presents a block diagram representation of a video processing device 125 in accordance with an embodiment of the present invention. In particular, video processing device 125 includes a receiving module 100, such as a television receiver, cable television receiver, satellite broadcast receiver, broadband modem, 3G transceiver or other information receiver or transceiver that is capable of receiving a received signal 98 and extracting one or more video signals 110 via time division demultiplexing, frequency division demultiplexing or other demultiplexing technique. Video record/playback module 102 is coupled to the receiving module 100 to encode the video signal in a first format corresponding to video display device 104 and in a second format corresponding to video display device 114. Video record/playback module 102 can playback the video signal in the first format as a processed video signal 112 for video display device 104 and can transfer a compressed video file, encoded in the second format, to video display device 114 when coupled to device interface 120.

In an embodiment of the present invention, the received signal 98 is a broadcast video signal, such as a television signal, high definition televisions signal, enhanced high definition television signal or other broadcast video signal that has been transmitted over a wireless medium, either directly or through one or more satellites or other relay stations or through a cable network, optical network or other transmission network. In addition, received signal 98 can be generated from a stored video file, played back from a recording medium such as a magnetic tape, magnetic disk or optical disk, and can include a streaming video signal that is transmitted over a public or private network such as a local area network, wide area network, metropolitan area network or the Internet.

Video signal 110 can include an analog video signal that is formatted in any of a number of video formats including National Television Systems Committee (NTSC), Phase Alternating Line (PAL) or Sequentiel Couleur Avec Memoire (SECAM). Further, video signal 110 can be in a digital format such as a Motion Picture Experts Group (MPEG) format (such as MPEG1, MPEG2 or MPEG4), Quicktime format, Real Media format, Windows Media Video (WMV) or Audio Video Interleave (AVI), or another digital video format, either standard or proprietary.

Video display devices 104 and 114 can include a television, monitor, computer, handheld device or other video display device that creates an optical image stream either directly or indirectly, such as by projection, based on processed video signal 112, the decoding of a digital video signal or the playback of a stored digital video file.

In an embodiment of the present invention, device interface 120 includes a wired link that allows the video processing device 114 to be coupled to the record/playback module 102 to transfer one or more stored digital video files for playback by the video processing device 114. The coupling can include a Universal Serial Bus (USB) connection, an Institute of Electrical and Electronics Engineers (IEEE) 1394 (Firewire) connection, or other wired connection that operates in accordance with either a standard or custom interface protocol. In this fashion, a video display device 114, such as an MP3/video player, game/video player PDA/video player, cellphone/video player or other handheld device can be coupled to the video processing device 125 to transfer compressed digital audio and/or video files between the two devices through a synchronization or “sync” operation, or by command from one or the other of the two devices. In addition, the video processing device 125 can optionally supply power to the video display device 114 when coupled, in order to operate or recharge the device.

In another embodiment of the present invention, the device interface 120 includes a wireless link between the video processing device 125 and the video display device 114 that operates in accordance with a wireless network protocol such as 802.11a,b,g,n (referred to generically as 802.11x), Bluetooth, Ultra Wideband (UWB) or other wireless connection that operates in accordance with either a standard or custom interface protocol.

In a further embodiment, the device interface 120 couples to video display device 114 using a removable memory, such as a removable drive, disk or memory card that is couplable to either the device interface 120 or the video display device 114. In this fashion, the removable memory can be written with a compressed digital video file when inserted in the device interface 120 and read when inserted in video display device 114 for playback of the associated content.

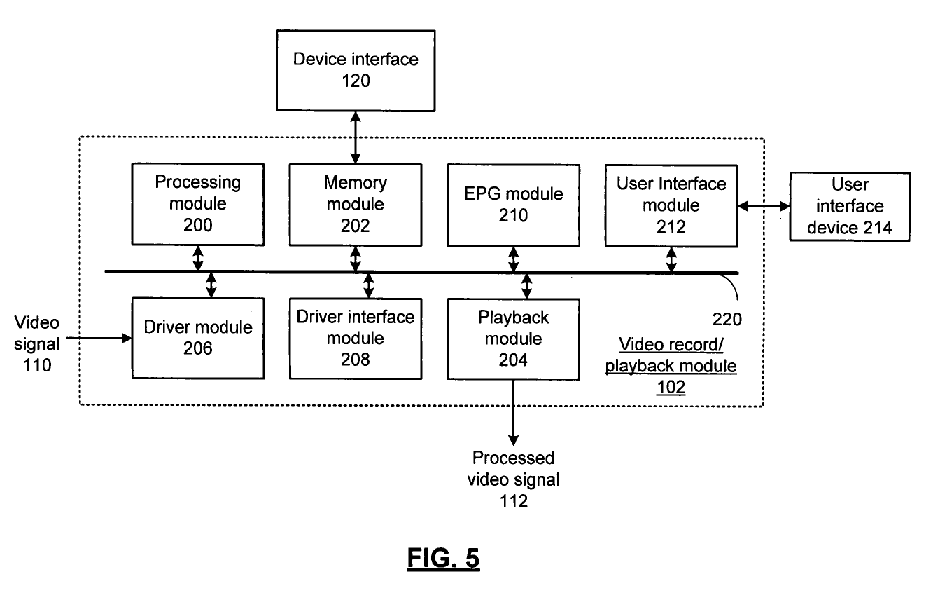

Further details regarding the operation an implementation of video record/playback module 102 are presented in conjunction with FIG. 5 that follows.

FIG. 5 presents a block diagram representation of a video record/playback module 102 in accordance with an embodiment of the present invention. In particular, video record/playback module 102 receives a video signal 110 and produces a processed video signal 112 for display on video display device 104 as either the playback of a compressed digital video file or a buffered live (realtime or near realtime) video signal that is produced in a format that corresponds to the format of video display device 104.

The video record/playback includes a processing module 200, and memory module 202 that are coupled to a plurality of other modules, such as Electronic Program Guide (EPG) module 210, user interface module 212, driver module 206, driver interface module 208, and playback module 204 via a bus 220. Processing module 200 can be implemented using a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 202. Memory module 202 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

The other modules of video record playback module 102 can be implemented in software, firmware or hardware, depending on the particular implementation of processing module 200. It should also be noted that the software implementations of the present invention can be stored on a tangible storage medium such as a magnetic or optical disk, read-only memory or random access memory and also be produced as an article of manufacture.

In operation, driver interface module 208 stores a plurality of record settings, the plurality of record settings corresponding to the video display devices that may be coupled thereto. In particular, this includes first settings corresponding to the video display device 104, and second settings corresponding to the video display device 114. Driver module 206 is coupled to the driver interface module 208 to encode the video signal 110 based on the first settings to produce a first processed video signal in a first format, and to contemporaneously encode the video signal 110 based on the second settings to produce a second processed video signal in a second format. In an embodiment of the present invention, the first format is different from the second format, based on the differences in resolution, compression format, compression depth, etc., between the video display device 104 and video display device 114. The first and second processed video signals can be streamed to support real-time or near real-time display of the video signal 110 by the video display devices 104 and/or 104 with buffering to allow the playback to be paused, rewound, fastforwarded, etc. In the alternative, one or more of the first and second processed video signals can be stored for later playback by playback module 204 or transferred to video display device 114 to enable autonomous playback of the stored video programming.

Memory module 202 is coupled to the driver module 206 for storing a plurality of compressed video files including a first compressed video file that is based on the first processed video signal. As discussed above, memory module can include a plurality of different memory devices. In an embodiment of the present invention, the plurality of compressed video files are stored in a large capacity storage medium such as a hard disk drive or flash memory, however other memory devices may likewise be used, and in particular, a removable memory device can be used to store the compressed video files that are formatted for video display device 114 in the embodiment where the device interface 120 is implemented with a removable memory.

EPG module 210 includes an electronic program guide that allows a user, through operation of user interface module 212 and one or more user interface devices 214 to obtain information regarding current or upcoming programs that can be viewed or recorded. Playback module 204 is coupled to memory module 202 to produce the processed video signal 112 based on a selected one of the plurality of compressed video files. User interface 212 and user interface device 214 provides a mechanism for a user of video processing device 125 to establish playback and record settings and preferences, to interactively choose programs to record, to select stored programs for playback, to pause, fast forward and rewind playback of compressed video files and buffered live video streams used to generate the processed video signal 112.

In an embodiment of the present invention, the one or more user interface devices 214 include a display, such as a separate liquid crystal, plasma or other display device capable of displaying text and/or graphics. Alternatively, user interface module 212 can generate overlay text, and graphics such as one or more menus to implement a menu driven graphical user interface that is presented on processed video signal 112 for display on video display device 104. In addition, user interface device 214 can include a number of buttons, a keyboard, a mouse, an infrared or wireless remote control or other pointing, indication or other user interface device that allows a user to select different choices or preferences, to browse and select from a plurality of menus and/or to otherwise interact with the record/playback module 102 in order to provide the use commands necessary to control the operation of the device.

While device interface 120 has been described in terms of being coupled to a single video display device 114, device interface 120 can likewise include multiple interfaces for coupling to two or more video display devices, with potentially different formats and through potentially different interfaces. For example, device interface can include a memory card slot for accepting a memory card used to couple compressed video files recorded by video record playback module 102 in a format suited to a handheld video display device, such as an LG CE500 video enabled cellphone, while further providing a USB 2.0 port to transfer compressed video files recorded by video record playback module 102 in a potentially different format to a digital audio/video player such as an Apple iPod, etc. Likewise the plurality of record settings can include three or more settings and the driver module can encode the video signal 110 to produce a three or more processed video signals in different formats.

While a particular architecture is described above, other architectures including alternative bus architectures, and architectures where the functionality of bus 220 is replaced by one or more direct connections or links, can likewise be implemented. In a particular embodiment of the present invention, the video processing device 125 is implemented using a computer having a TV tuner card, broadband modem or other receiver for selectively receiving video signal 110. Driver module 206, driver interface module 208, playback module 204, EPG module 210 and user interface module 212 are implemented by Microsoft Media Center Edition 2005 along with other software add-ons that operate in conjunction with the hardware of the computer to perform the functionality of video record/playback module 102.

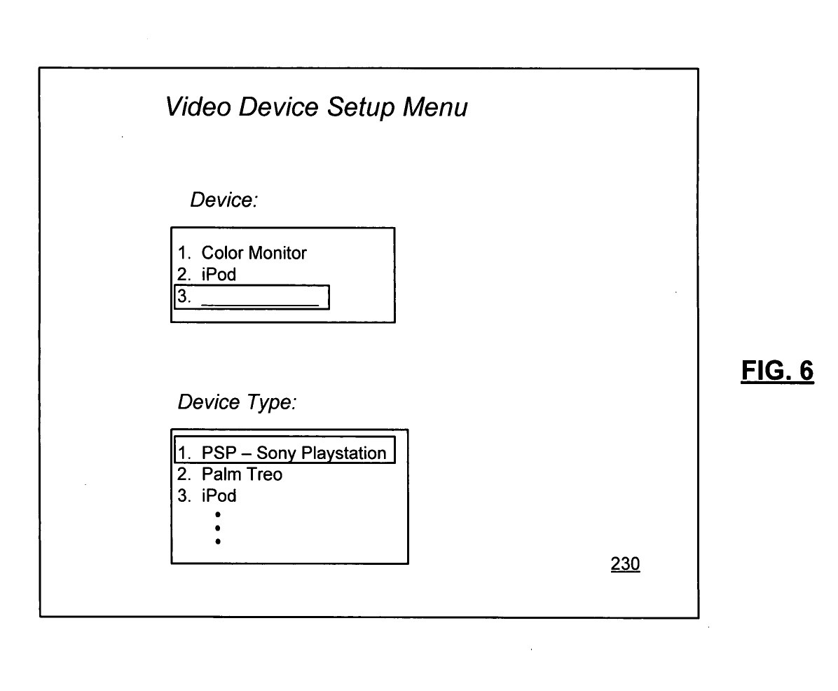

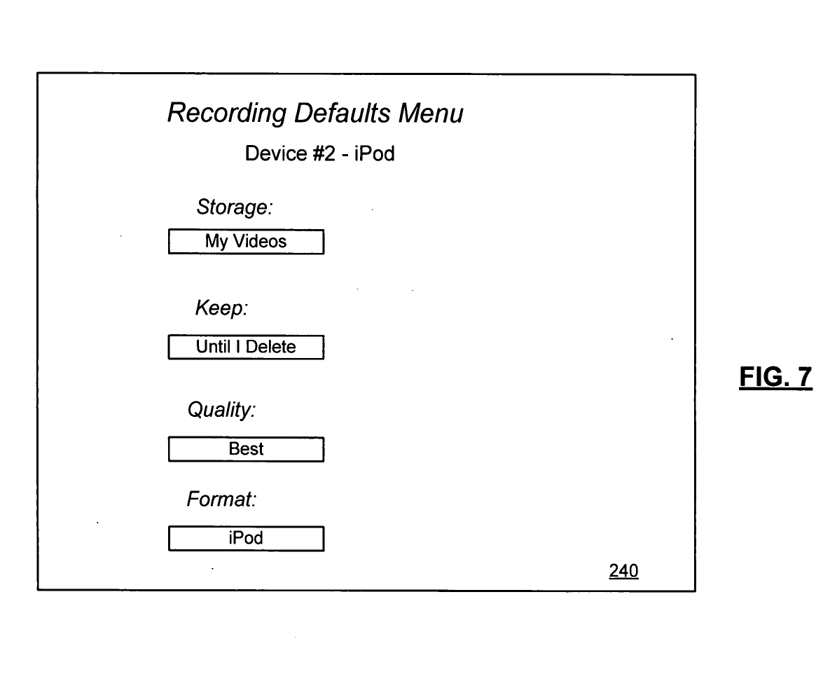

The further operation of video record/playback module 102 will described in addition to further examples and optional features in conjunction with FIGS. 6-8 that follow.

FIG. 6 presents a pictorial representation of a video device setup menu 230 in accordance with an embodiment of the present invention. In this embodiment, user interface module 212 selects the first settings based on a user selection of a first device type, selects the second settings based on a user selection of a second device type, etc. In particular, device setup menu 230 allows a user to establish the first settings, second settings, third settings, based on the characteristics of various devices that have prestored configurations. As shown in FIG. 6, two devices, a Color Monitor and an iPod have already been selected. The settings corresponding to a third device are selected by the user by selecting the particular one of a plurality of known devices from the list of device types. In this case, the user selects his or her third device from the list, in this case, a Sony PlayStation Portable from the list. In response, driver interface module 208 retrieves the particular compression format, screen resolution, etc., that are known to correspond to this particular device so that when a video signal 110 is recorded, a separate compressed video file can be recorded in a format that matches the characteristics of this device (as well as separate compressed video files for one or more other devices that have been set up in a similar fashion).

In an alternative embodiment, user interface module 212 can select one or more of the first and second settings, such as screen resolution, compression depth, and a compression format (e.g. digital video format such as a Motion Picture Experts Group (MPEG) format (such as MPEG1, MPEG2 or MPEG4), Quicktime format, Real Media format, Windows Media Video (WMV) or Audio Video Interleave (AVI), h.264 or another digital video format, either standard or proprietary), based on a user's direct selection of these particular settings for each corresponding device. While providing additional work for the user to determine and enter the particular settings for each device, this embodiment allows the flexibility of entering settings information for devices that may be configured differently or otherwise having settings that are optional to a particular device type or are unknown to the video record playback module 102.

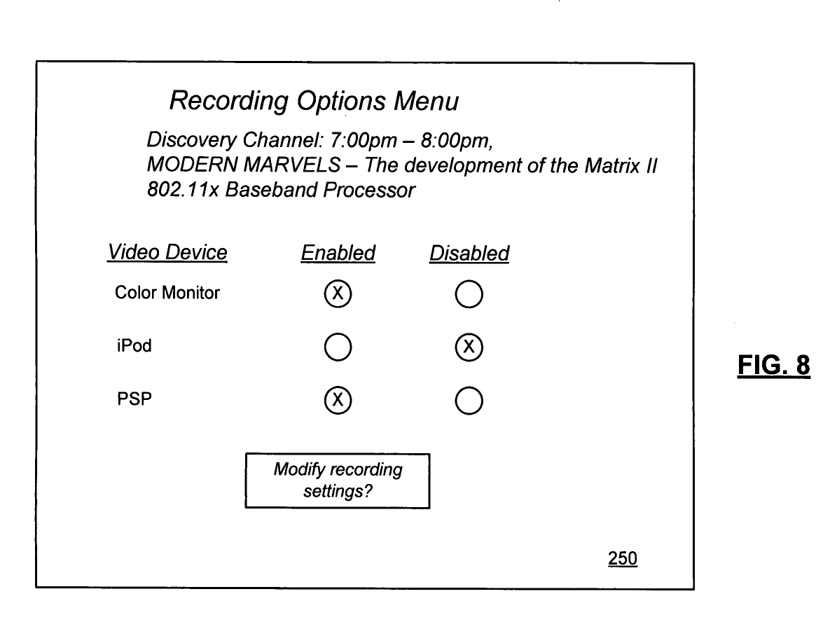

FIG. 7 presents a pictorial representation of a recording defaults menu 240 in accordance with an embodiment of the present invention. In particular a recording defaults menu 240 is presented that allows a user, through user interface device 214 and user interface module 212 to choose other settings for each video display device. In this example, the recording defaults can be set for the user's second device, the Apple iPod. Under the “Storage” section, the user selects the location that compressed video files will be stored, in this case, the “My Videos” folder of a hard disk drive of the video processing device 125. In the “Keep” section, the user selects the particular time period that the compressed video file will be kept, for instance, 1-day, 2-days, 5-days, 10 days, or, in this case, until deleted manually by the user. In the quality section, the user manually chooses the amount of compression (compression depth) by selecting one of a plurality of quality ratings, such as Low, Medium, High, or in this case, “Best”. In the “Format” section, the menu displays the format corresponding to the device, in this case the device type of “iPod”. Each video signal recorded is then recorded with these recording defaults, unless manually altered by the user prior to recording in a recording options menu, such as the recording options menu shown in FIG. 8.

FIG. 8 presents a pictorial representation of a recording options menu 250 in accordance with an embodiment of the present invention. In an embodiment, the driver interface module 208 selectively enables or disables a multiple recording signal for each video display device on a device by device basis. In response, the driver module 206 encodes the video signal to produce processed video signal for a particular video display device only when the multiple recording signal for that device is enabled. User interface module 212 selects whether the multiple recording signal is enabled based on a user selection, that optionally indicates a particular program to be recorded and the particular video display devices that are selected

In the example shown, the user has selected to record the Discovery Channel from 7:00 pm-8:00 pm, on that day, in order to record a particular episode of the television show, MODERN MARVELS, relating to the development of the Matrix II 802.11x baseband processor. The program will be recorded in a format corresponding to each of the selected video display devices, in this case, the color monitor and the Sony PlayStation Portable. The recording will proceed based on the recording defaults for each device, unless modified by the user by selecting “Modify recording settings” button, and modifying the particular recording settings for one or more of the devices for this particular recording.

In this fashion, the video record/playback module 102 will record this broadcast, creating two compressed video files that are stored. A first compressed video file formatted for playback on the color monitor and the second compressed video file formatted for playback on the Sony PSP. In an embodiment, the second compressed video file can be transferred to the Sony PSP when the device is coupled via the device interface 120. The user then has the option of watching the show via the color monitor of video processing system 125 or via the Sony PSP if the user is on the go.

While the embodiment above describes enabling the multiple recording feature on a device by device basis, in an embodiment of the present invention, the driver interface module 208 selectively enables or disables a multiple recording signal that applies only to the secondary devices (second and third devices—such as the iPod and Sony PSP in the examples above) that are coupled via the device interface 120. In response, the driver module 206 encodes the video signal to produce processed video signal for the second and third devices only when the multiple recording signal is enabled. As discussed above, the multiple recording signal can be selectively enabled or disabled for each particular program to be recorded.

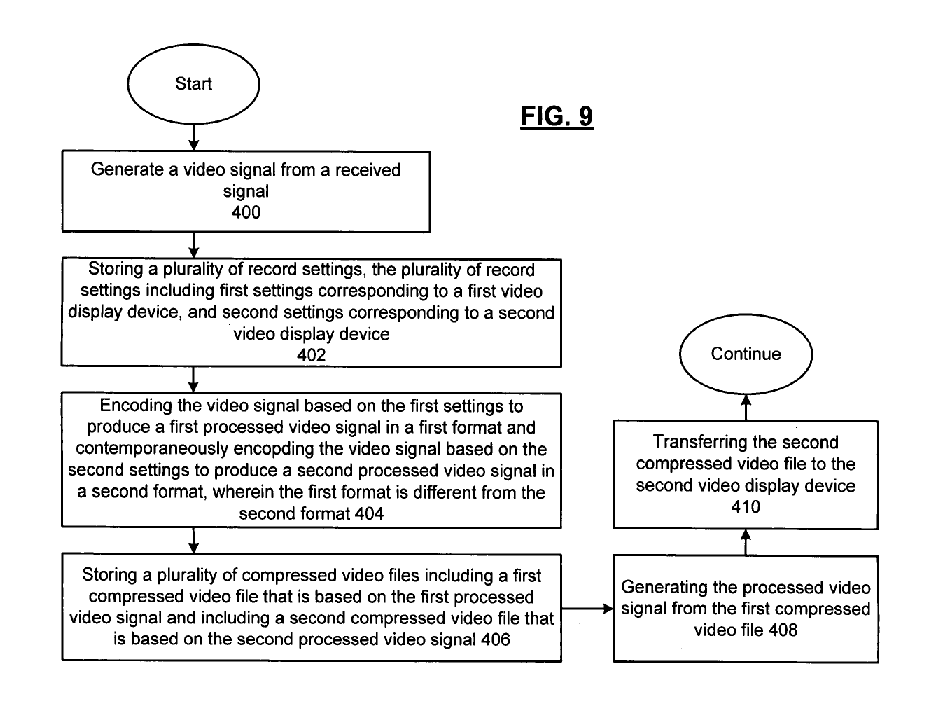

FIG. 9 presents a flowchart representation of a method in accordance with an embodiment of the present invention. In particular, a method is presented for use in conjunction with one or more of the features and functions described in association with FIGS. 1-8. In step 400, a video signal is generated from a received signal. In step 402 a plurality of record settings are stored, the plurality of record settings including first settings corresponding to a first video display device, and second settings corresponding to a second video display device. In step 404, the video signal is encoded based on the first settings to produce a first processed video signal in a first format, and contemporaneously encoding the video signal based on the second settings to produce a second processed video signal in a second format, wherein the first format is different from the second format. In step 406, a plurality of compressed video files are stored including a first compressed video file that is based on the first processed video signal and including a second compressed video file that is based on the second processed video signal. In step 408, a processed video signal is generated from the first compressed video file. In step 410, the second compressed video file is transferred to the second video display device.

In an embodiment of the present invention, the first device setting includes one of a screen resolution, and a compression format. In a further embodiment, the plurality of record settings include third settings and step 404 include encoding the video signal based on third settings corresponding to a third video display device to produce a third processed video signal in a third format.

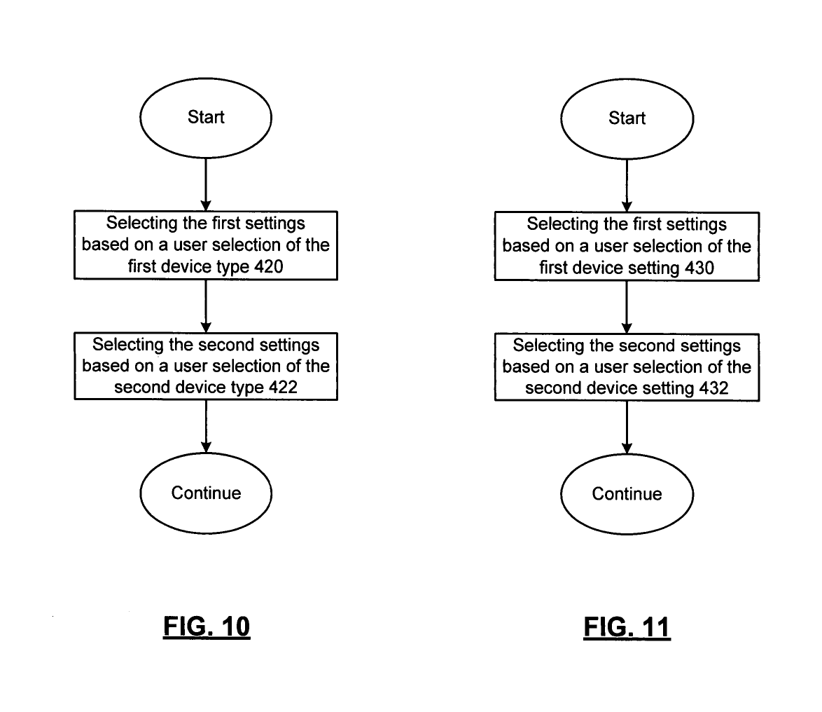

FIG. 10 presents a flowchart representation of a method in accordance with an embodiment of the present invention. In particular, a method is presented for use in conjunction with one or more of the features and functions described in association with FIGS. 1-9. In step 420, the first settings are selected based on a user selection of a first device type. In step 422, the second settings are selected based on a user selection of a second device type.

FIG. 11 presents a flowchart representation of a method in accordance with an embodiment of the present invention. In particular, a method is presented for use in conjunction with one or more of the features and functions described in association with FIGS. 1-9 and a potential alternative to the method of FIG. 10. In step 430 the first settings are selected based on a user selection of a first device setting. In step 432, the second settings are selected based on a user selection of a second device setting.

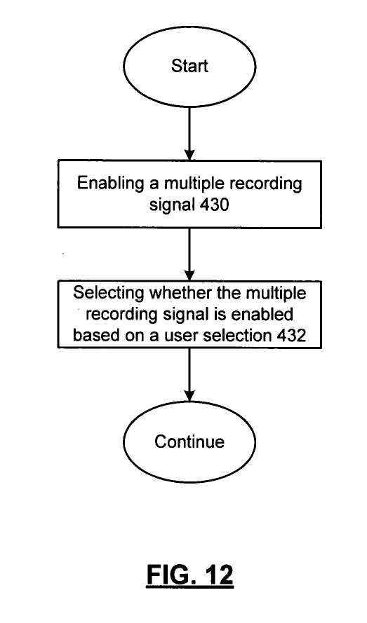

FIG. 12 presents a flowchart representation of a method in accordance with an embodiment of the present invention. In particular, a method is presented for use in conjunction with one or more of the features and functions described in association with FIGS. 1-11. In step 430 a multiple recording signal is enabled, wherein in step 404 the encoding of the video signal based on the second settings to produce a second processed video signal in a second format is performed in response to the enablement of the multiple recording signal. In step 432, the multiple recording signal is selectively enabled based on a user selection. In an embodiment, the user selection indicates a particular program to be recorded and whether the particular program is to be recorded with a multiple recording feature enabled.

In preferred embodiments, the various circuit components are implemented using 0.35 micron or smaller CMOS technology. Provided however that other circuit technologies, both integrated or non-integrated, may be used within the broad scope of the present invention.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As the term module is used in the description of the various embodiments of the present invention, a module includes a functional block that is implemented in hardware, software, and/or firmware that performs one or module functions such as the processing of an input signal to produce an output signal. As used herein, a module may contain submodules that themselves are modules.

Thus, there has been described herein an apparatus and method, as well as several embodiments including a preferred embodiment, for implementing a video processing device and a video recorder/player module. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A video processing device that produces a processed video signal for display on a first video display device, the video processing device comprising:
a receiving module that produces a video signal from a received signal;
video record/playback module that includes:
a driver interface module that stores a plurality of record settings, the plurality of record settings including first settings corresponding to a first video display device, and second settings corresponding to a second video display device;
a driver module, coupled to the driver interface module, that encodes the video signal based on the first settings to produce a first processed video signal in a first format, and that contemporaneously encodes the video signal based on the second settings to produce a second processed video signal in a second format, wherein the first format is different from the second format;
a memory module, coupled to the driver module, for storing a plurality of compressed video files including a first compressed video file that is based on the first processed video signal and including a second compressed video file that is based on the second processed video signal; and
a playback module, coupled to the memory module, that produces the processed video signal from the first compressed video file; and
a device interface, coupled to the memory module and coupleable to the second video display device, to transfer the second compressed video file to the second video display device.

2. The video processing device of claim 1 further comprising:
a user interface module that selects the first settings based on a user selection of a first device type and that selects the second settings based on a user selection of a second device type.

3. The video record/playback module of claim 1 further comprising:
a user interface module that selects the first settings based on a user selection of a first device setting and that selects the second settings based on a user selection of a second device setting.

4. The video processing device of claim 3 wherein the first device setting includes one of a screen resolution, and a compression format.

5. The video processing device of claim 1 wherein the driver interface enables a multiple recording signal and wherein the driver module encodes the video signal based on the second settings to produce a second processed video signal in a second format only when the multiple recording signal is enabled.

6. The video processing device of claim 7 further comprising:
a user interface module that selects whether the multiple recording signal is enabled based on a user selection.

7. The video processing device of claim 8 wherein the user selection indicates a particular program to be recorded and whether the particular program is to be recorded with a multiple recording feature enabled.

8. The video processing device of claim 1 wherein the plurality of record settings include third settings and wherein the driver module encodes the video signal based on third settings corresponding to a third video display device to produce a third processed video signal in a third format.

9. The video processing device of claim 1 wherein the device interface includes a wired link between the video processing device and the second video display device that operates in accordance with a standard interface protocol.

10. The video processing device of claim 1 wherein the device interface includes a wireless link between the video processing device and the second video display device that operates in accordance with a wireless network protocol.

11. A video record/playback module that receives a video signal from a receiving module and produces a processed video signal for display on a first video display device, the video record/playback module comprising:
a driver interface module that stores a plurality of record settings, the plurality of record settings including first settings corresponding to the first video display device, and second settings corresponding to a second video display device;
a driver module, coupled to the driver interface module, that encodes the video signal based on the first settings to produce a first processed video signal in a first format, and that contemporaneously encodes the video signal based on the second settings to produce a second processed video signal in a second format, wherein the first format is different from the second format;
a memory module, coupled to the driver module, for storing a plurality of compressed video files including a first compressed video file that is based on the first processed video signal.

12. The video record/playback module of claim 11 wherein the memory module stores a second compressed video file based on the second processed video signal.

13. The video record/playback module of claim 11 further comprising:
a playback module that produces the processed video signal based on a selected one of the plurality of compressed video files.

14. The video record/playback module of claim 11 further comprising:
a user interface module that selects the first settings based on a user selection of a first device type and that selects the second settings based on a user selection of a second device type.

15. The video record/playback module of claim 11 further comprising:
a user interface module that selects the first settings based on a user selection of a first device setting and that selects the second settings based on a user selection of a second device setting.

16. The video record/playback module of claim 15 wherein the first device setting includes one of a screen resolution, and a compression format.

17. The video record/playback module of claim 11 wherein the driver interface enables a multiple recording signal and wherein the driver module encodes the video signal based on the second settings to produce a second processed video signal in a second format only when the multiple recording signal is enabled.

18. The video record/playback module of claim 17 further comprising:
a user interface module that selects whether the multiple recording signal is enabled based on a user selection.

19. The video record/playback module of claim 18 wherein the user selection indicates a particular program to be recorded and whether the particular program is to be recorded with a multiple recording feature enabled.

20. The video record/playback module of claim 11 wherein the plurality of record settings include third settings and wherein the driver module encodes the video signal based on third settings corresponding to a third video display device to produce a third processed video signal in a third format.

21. A method comprising:
generating a video signal from a received signal;
storing a plurality of record settings, the plurality of record settings including first settings corresponding to a first video display device, and second settings corresponding to a second video display device;
encoding the video signal based on the first settings to produce a first processed video signal in a first format, and contemporaneously encoding the video signal based on the second settings to produce a second processed video signal in a second format, wherein the first format is different from the second format;
storing a plurality of compressed video files including a first compressed video file that is based on the first processed video signal and including a second compressed video file that is based on the second processed video signal;
generating the processed video signal from the first compressed video file; and
transferring the second compressed video file to the second video display device.

22. The method of claim 21 further comprising:
selecting the first settings based on a user selection of a first device type; and
selecting the second settings based on a user selection of a second device type.

23. The video record/playback module of claim 21 further comprising:
selecting the first settings based on a user selection of a first device setting; and
selecting the second settings based on a user selection of a second device setting.

24. The method of claim 23 wherein the first device setting includes one of a screen resolution, and a compression format.

25. The method of claim 21 further comprising:
enabling a multiple recording signal;
wherein the step of encoding the video signal based on the second settings to produce a second processed video signal in a second format is performed in response to the enablement of the multiple recording signal.

26. The method of claim 25 further comprising:
selecting whether the multiple recording signal is enabled based on a user selection.

27. The method of claim 6 wherein the user selection indicates a particular program to be recorded and whether the particular program is to be recorded with a multiple recording feature enabled.

28. The method of claim 21 wherein the plurality of record settings include third settings and the method further comprises:
encoding the video signal based on third settings corresponding to a third video display device to produce a third processed video signal in a third format.
